(19) United States
(12) Patent Application Publication
(10) Pub. No.: US 2020/0314382 A1
(43) Pub. Date: Oct. 1, 2020

(54) VIDEO FRAME INTERPOLATION METHOD, STORAGE MEDIUM AND TERMINAL

(71) Applicant: GUANGZHOU HUADUO NETWORK TECHNOLOGY CO., LTD., Guangzhou (CN)

(72) Inventors: Xiaodong Hu, Guangzhou (CN); Xuewen Wang, Guangzhou (CN); Lei Wang, Guangzhou (CN)

(21) Appl. No.: 16/902,496

(22) Filed: Jun. 16, 2020

Related U.S. Application Data
(63) Continuation of application No. PCT/CN2018/125086, filed on Dec. 28, 2018.

(30) Foreign Application Priority Data
Jan. 12, 2018 (CN) 201810032434.8

(51) Int. Cl. H04N 7/01; H04N 19/132; G06N 3/04; G06N 3/08

(52) U.S. Cl. CPC H04N 7/0135; G06N 3/08; G06N 3/04; H04N 19/132

(57) ABSTRACT

The present application provides a video frame interpolation method. The method includes the steps of: 1) successively determining a current frame, a frame prior to the current frame and a frame after the current frame of a video to which a frame to be interpolated; 2) inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set; and 3) performing frame interpolation on the video to which the frames to be interpolated via the video frame interpolation model, and obtaining frame interpolated video.

### CROSS-REFERENCE TO RELATED APPLICATIONS

The present application is a Continuation Application of PCT Application No. PCT/CN2018/125086 filed on Dec. 28, 2018, which claims the benefit of Chinese patent application number CN 201810032434.8 filed on Jan. 12, 2018 and titled “Video Frame Interpolation Method, Storage Media and Terminal”, the entirety of which is incorporated herein by reference in its entirety.

### TECHNICAL FIELD

The present application generally relates to image processing technology and, more particularly, relates to video frame interpolation method, storage medium and terminal.

### BACKGROUND OF THE INVENTION

When the network condition is undesirable, users usually need to actively drop frames of the video, to ensure the quality of the video picture. The video data is transmitted at a lower bit rate, and the high resolution and high frame rate of the video cannot be satisfied at the same time, which will affect the viewing effect of the video. Therefore, video frame interpolation is needed to ensure clear and smooth video playback.

In the prior art, video frame interpolation technology generally needs to perform motion estimation on the objects in the scene. The objects are inserted into correct position of the generated frame via motion compensation algorithm. Therefore, the effect of frame interpolation mainly depends on the quality of motion estimation and compensation. The video interpolation effect is undesirable.

### BRIEF SUMMARY OF VARIOUS EMBODIMENTS OF THE INVENTION

One object of the present invention is to provide a video frame interpolation method, storage medium and terminal, to solve the problem of poor video frame interpolation effect in the prior art and achieve desirable video frame insertion effect.

According to a first aspect of the present application, a video frame interpolation method according to one embodiment of the present application includes the steps of:

successively determining a current frame, a frame prior to the current frame and a frame after the current frame of a video to which a frame to be interpolated;

inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set; and performing frame interpolation on the video to which the frames to be interpolated via the video frame interpolation model, and obtaining frame interpolated video.

In one embodiment of the present application, the pre-set convolutional neural network model includes a first convolutional layer, a second convolutional layer and a third convolutional layer. The first convolutional layer and the second convolutional layer are configured to input the training set. The third convolutional layer is configured to generate an interpolated frame according to an output frame of the first convolutional layer and an output frame of the second convolutional layer.

In one embodiment of the present application, the first convolutional layer is configured to input the frame prior to the current frame or the frame after the current frame of the training set, and the second convolutional layer is configured to input the current frame, the frame prior to the current frame and the frame after the current frame of the of the training set.

In one embodiment of the present application, the training set includes a standard data set and an application scenario data set;

prior to inputting the current frame, the frame prior to the current frame and the frame after the current frame of the video to which the frames to be interpolated into a pre-configured video frame interpolation model, the method further includes the steps of:

successively determining a current frame, a frame prior to the current frame and a frame after the current frame of the standard data set;

inputting the current frame, a frame prior to the current frame and a frame after the current frame of the standard data set into the pre-set convolutional neural network model for training, to obtain an initial model;

successively determining the current frame, a frame prior to the current frame and a frame after the current frame of the application scenario data set; and

inputting the current frame, the frame prior to the current frame and the frame after the current frame of the application scenario data set into the initial model for training, to generate the video frame interpolation model.

In one embodiment of the present application, the application scenario data set includes a live video data set or a short video data set.

In one embodiment of the present application, after generating the video frame interpolation model, the method further includes the step of compressing the video frame interpolation model.

In one embodiment of the present application, the step of compressing the video frame interpolation model includes the step of cropping the video interpolation frame model.

In one embodiment of the present application, the video frame interpolation model is arranged on a server or a client end.

According to a second aspect of the present application, one embodiment of the present application provides a computer-readable storage medium having a computer program stored therein. The computer program is executed by a processor to implement the video frame interpolation method of the present application.

According to a third aspect of the present application, one embodiment of the present application provides a terminal, and the terminal includes:

one or more processors; and

a storage device configured for storing one or more programs,

wherein when the one or more programs are executed by the one or more processors, the one or more processors implement the video frame interpolation method of the present application.

Aiming at actively dropping frames to ensure picture quality in the weak network condition, according to the video frame interpolation method, storage medium and terminal of the present application, the video is interpolated through a preconfigured video frame interpolation model, to solve the problem of being difficult to reconcile the video resolution with the frame rate in the weak network situation, which can effectively improve the smoothness of the video, so that the audience can obtain clear and smooth video, thereby improving the viewing experience.

In addition, the video frame interpolation model is obtained by training the end to end convolutional neural network model in the training set, and performing the video frame interpolation according to the video frame interpolation model. Therefore, desirable frame interpolation effect relative to the conventional method can be achieved.

Other aspects and advantages of the present application will be partially detailed in the following description, which will be apparent in view of the following description or can be learned through the implementation of the present application.

### BRIEF DESCRIPTION OF THE DRAWINGS

The above-mentioned and/or additional aspects and advantages of the present application will become apparent and ready to understand from the following description of the embodiments in view of the accompanying drawings, in which:

FIG. 1 is a schematic flowchart of a video frame interpolation method according to one embodiment of the present application;

FIG. 2 is a schematic structural diagram of a pre-set convolutional neural network model according to one embodiment of the present application;

FIG. 3 is a schematic structural diagram of a pre-set convolutional neural network model according to another embodiment of the present application; and

FIG. 4 is a schematic structural diagram of a terminal according to one embodiment of the present application.

### DETAILED DESCRIPTION OF THE INVENTION

The embodiments of the present application will now be described in more detail below. Examples of the embodiments are shown in the drawings, in which same or similar reference numerals refer to same or similar elements or elements having same or similar functions. The embodiments described below with reference to the drawings are exemplary, and are only used to explain the present application and cannot be construed as limiting the present application.

It should be understandable by one ordinary skilled in the art that, unless specifically stated, the singular forms “a”, “an”, “said” and “the” used herein can also include the plural forms. It should be further understood that the term “comprising” used in the description of the present application refers to the presence of the features, integers, steps, operations, elements, assembly and/or combination thereof, but does not exclude the presence or addition of one or more other features, integers, steps, operations, elements, assembly, and/or combination thereof. The term “and/or” as used herein includes all or any unit of one or more listed associated items or combinations thereof.

One ordinary skilled in the art can understand that, unless otherwise defined, all terms (including technical terms and scientific terms) used in the present application have the same meaning as those generally understood by one ordinary skilled in the art. It should also be understood that, terms such as those defined in a general dictionary should be understood to have a meaning consistent with the meaning in the context of the prior art. Unless specifically defined in the present application, it will not be explained as idealized or excessive meaning.

One ordinary skilled in the art can understand that, the terms of “terminal” and “terminal device” used herein not only include wireless signal receiver devices, which only have wireless signal receiver devices without transmitting capabilities, but also include a device for receiving and transmitting hardware, which includes a device capable of performing receiving and transmitting hardware for bidirectional communication on a bidirectional communication link. Such devices may include: cellular or other communication devices with single-line display or multi-line display, or cellular or other communication devices without multi-line display; PCS (Personal Communications Service), which can combine voice, data processing, fax and/or data communication capabilities; PDA (Personal Digital Assistant), which include radio frequency receivers, pagers, Internet/Intranet access, web browsers, notepads, calendars and/or GPS (Global Positioning System) receiver; conventional laptop and/or palmtop computer or other device that has and/or includes a conventional radio frequency receiver and/or palmtop computer or other device. As used herein, “terminal” and “terminal device” may be portable, transportable, installed in a vehicle (aeronautical, marine, and/or terrestrial), or suitable and/or configured to operate locally, and/or operate at any other location on the earth and/or space in a distributed form. The terms of “terminal” and “terminal device” used herein may also be a communication terminal, an Internet terminal, a music/video playback terminal, for example, a PDA, MID (Mobile Internet Device,) and/or mobile phones having music/video playback functional, or smart TVs, set-top boxes and other devices.

One ordinary skilled in the art can understand that, the concepts of server, cloud and remote network equipment used here have equivalent effects, including but not limited to computers, network hosts, a single network server, multiple network server sets, or cloud consisting of multiple servers, wherein the cloud consists of a large number of computers or network servers based on cloud computing. Cloud computing is a type of distributed computing, i.e. a super virtual computer consisting of a group of loosely coupled computer sets. In the embodiments of the present application, the communication between the remote network device, the terminal device and the WNS server can be achieved through any communication method, including but not limited to, mobile communication based on 3GPP, LTE, WIMAX, computer network communication based on TCP/IP, UDP protocol, and short-range wireless transmission based on bluetooth and infrared transmission standards.

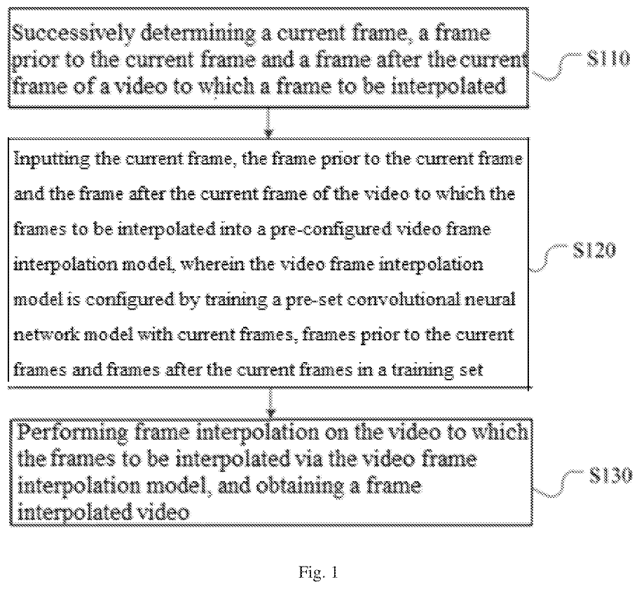

As shown in the schematic flowchart of FIG. 1, a video frame interpolation method according to one embodiment of the present application includes the steps of:

S110: successively determining a current frame, a frame prior to the current frame and a frame after the current frame of a video to which a frame to be interpolated.

Frame rate is used to measure the number of displayed frames. The video to which a frame to be interpolated may be a live video with a low frame rate, a short video with a low frame rate, or another video with a low frame rate, which is not limited in the present application. The manner for determining the current frame, a frame prior to the current frame and a frame after the current frame can be determined according to actual needs. For example, all the frames of the video to which the frames to be interpolated are arranged in chronological order, and one frame is selected as the current frame from front to back, until all frames are determined as the current frame, wherein, when the first frame is the current frame, there is no frame prior to the current frame, so it can be determined from the second frame in actual operation.

S120. inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set.

The manner for determining the current frame, the frame prior to the current frame and the frame after the current frame of the training set can also be determined according to actual needs. The convolutional neural network model is a feedforward neural network model. Artificial neurons can respond to surrounding units and perform large-scale image processing. The training set contains a large number of training samples. The current frame, the frame prior to the current frame and the frame after the current frame of each training sample are determined. The convolutional neural network model is then trained based on the current frame, the frame prior to the current frame and the frame after the current frame of each training sample, to generate a video frame interpolation model. The generated video frame interpolation model is configured to interpolate the video to which the frames to be interpolated.

S130. performing frame interpolation on the video to which the frames to be interpolated via the video frame interpolation model, and obtaining frame interpolated video.

After inputting the video to which the frames to be interpolated into the video frame interpolation model, the video frame interpolation model can generate interpolated frame according to the input video to which the frames to be interpolated, and interpolate the generated interpolated frame into the video to which the frames to be interpolated. For instance, interpolate the current frame and the frame prior to the current frame, to realize the frame interpolation of the video to which the frames to be interpolated and obtain high frame rate video, i.e. smooth video.

Aiming at actively dropping frames to ensure picture quality in the weak network condition, according to the video frame interpolation method, storage medium and terminal of the present application, the video is interpolated through a pre-configured video frame interpolation model, to solve the problem of being difficult to reconcile the video resolution with the frame rate in the weak network situation, which can effectively improve the smoothness of the video, so that the audience can obtain clear and smooth video, thereby improving the viewing experience. In addition, the video frame interpolation model is obtained by training the end to end convolutional neural network model in the training set, and performing the video frame interpolation according to the video frame interpolation model. Therefore, desirable frame interpolation effect relative to the conventional method can be achieved. In addition, the video interpolation based on the video interpolation model is simpler to implement than the motion estimation and compensation method in the prior art.

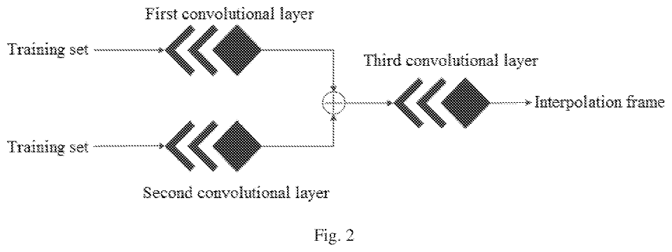

As shown in the schematic structural diagram of FIG. 2, the pre-set convolutional neural network model includes a first convolutional layer, a second convolutional layer, and a third convolutional layer. The first convolutional layer and the second convolutional layer are configured to input the training set. The third convolutional layer is configured to generate an interpolated frame according to the output frame of the first convolutional layer and the output frame of the second convolutional layer. In other words, the output frame of the first convolutional layer and the output frames of the second convolutional layer are cascaded and input into the third convolutional layer. The third convolutional layer generates an interpolated frame, wherein the interpolated frame is the generated frame of the video to which the frames to be interpolated.

It should be understood that, the first convolutional layer, the second convolutional layer, and the third convolutional layer may each include one convolutional layer, or may include multiple convolutional layers, which is not limited in the present application. In addition, according to the structure shown in FIG. 2, the user can also make simple modifications, such as adding other layers, which are all within the scope of the present application.

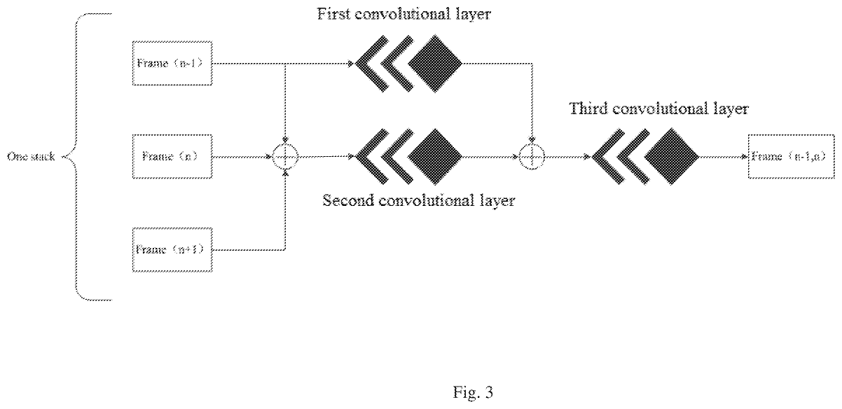

FIG. 3 is a schematic structural diagram of a pre-set convolutional neural network model according to another embodiment of the present application. In FIG. 3, One stack represents a stack, and there are multiple frame data in the stack, including Frame (n−1), Frame (n) and Frame (n+1) as shown. Frame (n) is the current frame n, Frame (n−1) is the frame prior to Frame (n), Frame (n+1) is the frame after Frame (n), and Frame (n−1, n) is the generated interpolated frame.

As shown in FIG. 3, in one embodiment of the present application, the first convolutional layer is configured to input the frame prior to the current frame or the frame after the current frame of the training set. The second convolutional layer is configured to input the current frame, the frame prior to the current frame, and the frame after the current frame of the training set. In other words, the current frame of the training set, the frame prior to the current frame, and the frame after the current frame are concatenated and input into the second convolutional layer. Then, the output frame of the first convolutional layer and the output frame of the second convolutional layer are concatenated and input into the third convolutional layer. The third convolutional layer can generate an interpolated frame, and the interpolated frame is interpolated into the video to which the frames to be interpolated, to obtain high frame rate video. It should be noted that, FIG. 3 only illustrates one case of the pre-set convolutional neural network model, and the other case is the same.

In one embodiment of the present application, the training set includes a standard data set and an application scenario data set. Prior to inputting the current frame, the frame prior to the current frame and the frame after the current frame of the video to be which the frame to interpolated into a video frame interpolation model generated in advance, the method further includes the steps of:

S070: successively determining a current frame, a frame prior to the current frame and a frame after the current frame of the standard data set.

The standard data set contains a large amount of standard data. In implementation, the standard data set can be formed from existing standard data captured from internet. The current frame, the frame prior to the current frame, and the frame after the current frame of each standard data are determined in an order set in advance.

S080. inputting the current frame, a frame prior to the current frame and a frame after the current frame of the standard data set into the pre-set convolutional neural network model for training, to obtain an initial model.

Pre-training the pre-set convolutional neural network model via the standard data sets, so that the pre-set convolutional neural network model has a good performance on the standard data set.

S090: successively determining the current frame, a frame prior to the current frame and a frame after the current frame of the application scenario data set.

Application scenario data accumulated by the company for a long time can be used as the data for training the initial model. Application scenario data is data in the scenario applied by the method according to one embodiment of the present application. For example, if the method according to the embodiment of the present application is used to interpolate frames of live video, then the application scenario data set includes the live video data set. For another example, the method according to one embodiment of the present application is used to interpolate frames of short videos, and the application scenario data set includes a short video data set. The current frame, the frame prior to the current frame, and the frame after the current frame of each application scenario data are determined in sequence according to an order set in advance.

S100. inputting the current frame, the frame prior to the current frame and the frame after the current frame of the application scenario data set into the initial model for training, to generate the video frame interpolation model.

After the initial model is determined, the initial model needs to be fine-adjusted according to the specific application scenario, to obtain a more accurate video frame interpolation model suitable for the specific application scenario. Therefore, after the initial model is obtained, the initial model is adjusted according to the application scenario data, so that the initial model has a good performance in the specific application scenario and the video interpolation frame model can be obtained.

In order to reduce the model volume at the cost of minimal effect loss and facilitate the arrangement of the mobile terminal, in one embodiment of the present application, after generating the video interpolation frame model, the method further includes the step of compressing the video frame interpolation model. In implementation, compressing the video interpolation frame model includes cropping the video frame interpolation model. By optimizing and cropping the model, the model volume can be compressed without losing or minimizing the loss of frame interpolation effect.

It should be understood that the present application does not limit the specific manner of compressing the model. The user can also compress the model in other ways according to actual needs.

In one embodiment of the present application, the video frame interpolation model is arranged on a server or a client. When the video frame interpolation model is arranged on the server, the user uploads the low frame rate video to the server. The server interpolates the low frame rate video via the video frame interpolation model, to obtain a high frame rate smooth video. The smooth video having high frame rate is distributed to all clients, and the audience can see the smooth video.

When the video frame interpolation model is arranged on the client end, when the client receives the low frame rate video distributed by the server, the video frame interpolation model interpolates the low frame rate video, to obtain the high frame rate video. Then the audience can watch the smooth video directly.

In order to better understand the above mentioned embodiments, the following two examples will be described in detail.

1. Live Video

Live video requires high real-time performance. When the network environment of the broadcaster is poor, the video must be compressed to complete the real-time upload to the server. When the network environment of the viewing end is poor, only the compressed video can be downloaded from the server, to meet real-time requirements. For high-compression ratio video, the clarity and the fluency are a pair of difficult factors hard to reconcile with each other. If high-resolution live video is intended to be presented to the viewer, it will inevitably lead to the occurrence of lag. One embodiment of the present application is to solve the contradiction, which can enable the audience to obtain clear and smooth live video under the condition of limited network bandwidth and improve the viewing experience.

According to different positions of the video frame interpolation model, the embodiments of the present application provide two solutions: i) the video frame interpolation model is arranged on the server, the low frame rate video uploaded by the broadcaster is converted into smooth video and the smooth video is distributed to the audiences, to solve problems of poor network condition of the broadcaster; ii) the video frame interpolation model is arranged on the viewing device, i.e. the client end, the low frame rate video received by the viewing end is converted into a smooth video, and the smooth video is directly displayed to the audience, to solve the problem of poor network conditions at the broadcast end and the viewing end. There are certain requirements for the computing power of the viewing device in solution ii).

2. Short Video

Short video production and playback do not require high real-time performance, but the technology according to the embodiments of the present application can also be used to reduce the flow consumption of video upload and video download. Specifically: i) when arranged on the server, the short video producers can upload high compression ratio low frame rate video to the server, the short video is processed by the server end into smooth video and distributed, thereby saving the video upload flow consumption; ii) when arranged on the viewing end device, i.e. the client, short video viewer can download the high compression ratio low frame rate video from the server, and obtain clear and smooth video after local processing. The users directly watch the processed clear and smooth video, thereby saving the flow consumption of video upload and video download.

One embodiment of the present application further provides a computer-readable storage medium having a computer program stored therein. When the program is executed by a processor, the video frame interpolation method of the present application is implemented. The storage medium includes but is not limited to any type of disk (including floppy disk, hard disk, optical disk, CD-ROM, and magneto-optical disk), ROM (Read-Only Memory), RAM (Random Access Memory), EPROM (Erasable Programmable Read-Only Memory), EEPROM (Electrically Erasable Programmable Read-Only Memory), flash memory, magnetic card or light card. In other words, the storage medium includes any medium that stores or transmits information in a readable form by a device (for example, a computer). It can be read-only memory, magnetic disk or optical disk.

One embodiment of the present application provides a terminal, and the terminal includes:

one or more processors; and

a storage device configured for storing one or more programs,

wherein when the one or more programs are executed by the one or more processors, the one or more processors implement the foregoing video frame interpolation method of the present application.

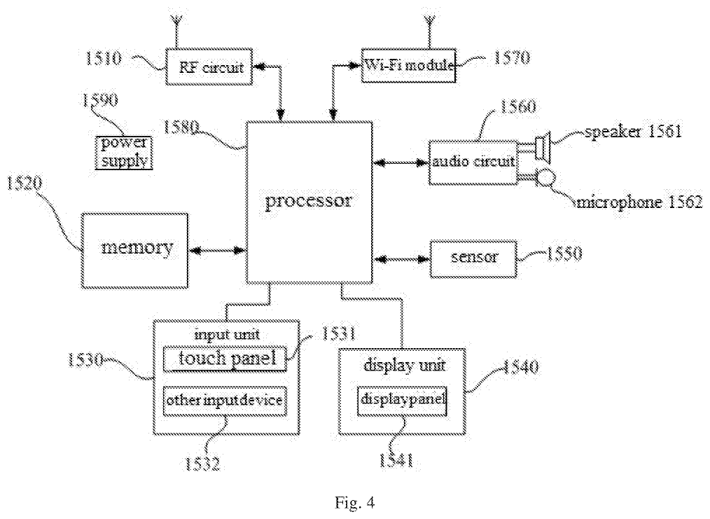

As shown in FIG. 4, for convenience of description, only parts related to the embodiments of the present application are shown. The specific technical details not disclosed can refer to the method embodiments of the present application. The terminal can be any terminal device including a mobile phone, a tablet computer, a PDA (Personal Digital Assistant), a POS (Point of Sales), an in-vehicle computer, etc Taking the terminal as a mobile phone for example:

FIG. 4 is a block diagram of a partial structure of a mobile phone related to a terminal according to one embodiment of the present application. Referring to FIG. 4, the mobile phone includes: a radio frequency RF) circuit 1510, a memory 1520, an input unit 1530, a display unit 1540, a sensor 1550, an audio circuit 1560, a wireless fidelity (Wi-Fi) module 1570, a processing 1580 and a power supply 1590. One ordinary skilled in the art can understand that the structure of the mobile phone shown in FIG. 4 does not constitute a limitation on the mobile phone, the mobile phone may include more or fewer components than those illustrated, or combine certain components, or arrange different components.

The components of the mobile phone will be described in detail with reference to FIG. 4:

The RF circuit 1510 can be used to receive and send signals during sending and receiving information or during a call. In particular, after receiving the downlink information of the base station, the information is processed by the processor 1580. The designed uplink data is sent to the base station. Generally, the RF circuit 1510 includes but is not limited to an antenna, at least one amplifier, a transceiver, a coupler, a low noise amplifier (LNA), and a duplexer. In addition, the RF circuit 1510 can also communicate with the network and other devices via wireless communication. The above wireless communication can use any communication standard or protocol, including but not limited to Global System of Mobile communication (GSM), General Packet Radio Service (GPRS), Code Division Multiple Access (Code Division (CDMA), Wideband Code Division Multiple Access (WCDMA), Long Term Evolution (LTE), e-mail, and Short Messaging Service (SMS).

The memory 1520 may be used to store software programs and modules. The processor 1580 executes various functional applications and data processing of the mobile phone by running the software programs and modules stored in the memory 1520. The memory 1520 may mainly include a storage program area and a storage data area, wherein the storage program area may store an operating system, at least one function required application program (such as a video interpolation function). The storage data area may store the created data (such as video frame interpolation model), according to the use of the mobile. In addition, the memory 1520 may include a high-speed random access memory, and may also include a non-volatile memory, such as at least one magnetic disk storage device, a flash memory device, or other volatile solid-state storage devices.

The input unit 1530 may be used to receive input numeric or character information, and generate key signal input related to user settings and function control of the mobile phone. Specifically, the input unit 1530 may include a touch panel 1531 and other input devices 1532. The touch panel 1531, also known as touch screen, can collect user's touch operations on or near the touch panel (for example, the user uses any suitable objects or accessories, such as fingers, stylus, on or near the touch panel 1531), and drive the corresponding connection device according to the pre-set program. Optionally, the touch panel 1531 may include a touch detection device and a touch controller, wherein the touch detection device detects the user's touch orientation, detects the signal brought by the touch operation, and transmits the signal to the touch controller. The touch controller receives touch information from the touch detection device and converts it into contact coordinates, and then sends them to the processor 1580, and can receive the command sent by the processor 1580 and execute it. In addition, the touch panel 1531 may be implemented in various types, such as resistive, capacitive, infrared and surface acoustic waves. In addition to the touch panel 1531, the input unit 1530 may also include other input devices 1532. Specifically, other input devices 1532 may include but not limited to one or more of a physical keyboard, function keys (such as volume control keys, switch keys), trackball, mouse, joystick, and so on.

The display unit 1540 may be used to display information input by the user or information provided to the user and various menus of the mobile phone. The display unit 1540 may include a display panel 1541. Alternatively, the display panel 1541 may be configured in the form of a liquid crystal display (LCD), an organic light-emitting diode (OLED), or the like. Further, the touch panel 1531 may cover the display panel 1541. When the touch panel 1531 detects a touch operation on or near it, the touch operation is transmitted to the processor 1580 to determine the type of touch event. The processor 1580 then provides corresponding visual output on the display panel 1541 according to the type of the touch event. Although in FIG. 4, the touch panel 1531 and the display panel 1541 are two independent components to realize the input and input functions of the mobile phone, in some embodiments of the present application, the touch panel 1531 and the display panel 1541 may be integrated to realize the input and output functions of the mobile phone.

The mobile phone may further include at least one sensor 1550, such as a light sensor, a motion sensor, and other sensors. Specifically, the light sensor may include an ambient light sensor and a proximity sensor, wherein the ambient light sensor may adjust the brightness of the display panel 1541 according to the brightness of the ambient light, and the proximity sensor may close the display panel 1541 and/or the backlight when the mobile phone moves to the ear. As a type of motion sensor, the accelerometer sensor can detect the magnitude of acceleration in various directions (generally three axes), can detect the magnitude and direction of gravity when at rest, and can be used to identify mobile phone gesture applications (such as horizontal and vertical screen switching, related games, magnetometer attitude calibration), vibration recognition related functions (such as pedometer, percussion). As for other sensors that can be configured in mobile phones, such as gyroscopes, barometers, hygrometers, thermometers, infrared sensors will not be described in detail any more.

The audio circuit 1560, the speaker 1561 and the microphone 1562 can provide an audio interface between the user and the mobile phone. The audio circuit 1560 can transmit the converted electrical signal of the received audio data to the speaker 1561, which is converted into a voiceprint signal output by the speaker 1561. On the other hand, the microphone 1562 converts the collected voiceprint signal into an electrical signal which is received by the audio circuit 1560 and is converted into audio data. The audio data is sent to the processor 1580 and processed before being further sent to another mobile phone via the RF circuit 1510, or the audio data is sent to the memory 1520 for further processing.

Wi-Fi is a short-distance wireless transmission technology. The mobile phone can help users to send and receive emails, browse web pages, and access streaming media through the Wi-Fi module 1570, which provides users with wireless broadband internet access. Although FIG. 4 shows the Wi-Fi module 1570, it should be understood that, the Wi-Fi module 1570 is not a necessary component of a mobile phone, and the Wi-Fi module 1570 can be omitted according to actual requirement without changing the scope of the present application.

The processor 1580 is the control center of the mobile phone, which uses various interfaces and lines to connect the various parts of the mobile phone. Various functions and data processing of the mobile phone can be implemented via running or implementing the software programs and/or modules stored in the memory 1520 and calling the data stored in the memory 1520, so as to monitor the mobile phone as a whole. Optionally, the processor 1580 may include one or more processing units. Preferably, the processor 1580 may integrate an application processor and a modem processor, wherein the application processor mainly processes the operating system, user interface, and application programs. The modem processor mainly handles wireless communication. It can also be understood that the foregoing modem processor may not be integrated into the processor 1580.

The mobile phone also includes a power supply 1590 (such as a battery) that supplies power to various components. Preferably, the power supply 1590 can be logically connected to the processor 1580 via the power management system, to realize functions such as charging, discharging, and power consumption management through the power management system.

Although not shown, the mobile phone may also include a camera, a Bluetooth module, which will not be repeated in detail here.

Compared with the prior art, the video frame interpolation method, storage medium and terminal of the present application have the following advantages:

i) The present application can achieve efficient video frame interpolation based on the end-to-end video frame interpolation model, to solve the problem of difficulty in reconciling the video resolution and frame rate in the case of weak network, achieve the frame interpolation effect far exceeding the traditional method, so that the audience can get a clearer and smoother video and can obtain improved viewing experience.

ii) The present application can provide a possible solution for reducing the flow consumption during video transmission and save the enterprise network bandwidth.

iii) The present application can optimize and compress the video interpolation frame model, and reduce the size of the video interpolation frame model at the cost of minimal effect loss, which facilitates the arrangement of the mobile terminal.

It should be understood that although the steps in the illustrated flowchart of the drawings are displayed in order according to the arrows, the steps are not necessarily executed in the order indicated by the arrows. Unless there is a clear description in the present application, the execution of the steps is not strictly limited in order, and the steps can be executed in other orders. Moreover, at least a part of the steps in the illustrated flowchart of the drawings may include multiple sub-steps or multiple stages. These sub-steps or stages are not necessarily executed at the same time, but may be executed at different times, and the order of execution is not necessarily performed sequentially, but may be executed in turn or alternately with at least a part of other steps or sub-steps or stages of other steps.

The above is only part of the embodiments of the present application. It should be noticed that for one ordinary skilled in the art, without departing from the principles of the present application, other improvements and modifications can be made, which should also be regarded as within the scope of the present patent application.

What is claimed is:

1. A video frame interpolation method, comprising the steps of:
successively determining a current frame, a frame prior to the current frame and a frame after the current frame of a video to which a frame to be interpolated;
inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set; and
performing frame interpolation on the video to which the frames to be interpolated via the video frame interpolation model, and obtaining a frame interpolated video.

2. The video frame interpolation method according to claim 1, wherein the pre-set convolutional neural network model comprises a first convolutional layer, a second convolutional layer and a third convolutional layer, the first convolutional layer and the second convolutional layer are configured to input the training set, the third convolutional layer is configured to generate an interpolated frame according to an output frame of the first convolutional layer and an output frame of the second convolutional layer.

3. The video frame interpolation method according to claim 2, wherein the first convolutional layer is configured to input the frame prior to the current frame or the frame after the current frame of the training set, and the second convolutional layer is configured to input the current frame, the frame prior to the current frame and the frame after the current frame of the of the training set.

4. The video frame interpolation method according to claim 1, wherein the training set comprises a standard data set and an application scenario data set, prior to inputting the current frame, the frame prior to the current frame and the frame after the current frame of the video to which the frames to be interpolated into a preconfigured video frame interpolation model, the method further includes the steps of:
successively determining a current frame, a frame prior to the current frame and a frame after the current frame of the standard data set;
inputting the current frame, a frame prior to the current frame and a frame after the current frame of the standard data set into the pre-set convolutional neural network model for training, to obtain an initial model;
successively determining the current frame, a frame prior to the current frame and a frame after the current frame of the application scenario data set; and
inputting the current frame, the frame prior to the current frame and the frame after the current frame of the application scenario data set into the initial model for training, to generate the video frame interpolation model.

5. The video frame interpolation method according to claim 4, wherein the application scenario data set comprises a live video data set or a short video data set.

6. The video frame interpolation method according to claim 4, wherein after generating the video frame interpolation model, the method further comprises the step of compressing the video frame interpolation model.

7. The video frame interpolation method according to claim 6, wherein the step of compressing the video frame interpolation model comprises cropping the video frame interpolation model.

8. The video frame interpolation method according to claim 1, wherein the video frame interpolation model is arranged on a server or a client end.

9. A computer-readable storage medium having a computer program stored therein, wherein when the program is executed by a processor, a video frame interpolation method is implemented, and the video frame interpolation method comprises the steps of:
successively determining a current frame, a frame prior to the current frame and a frame after the current frame of a video to which a frame to be interpolated;
inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set; and
performing frame interpolation on the video to which the frames to be interpolated via the video frame interpolation model, and obtaining a frame interpolated video.

10. The computer-readable storage medium according to claim 9, wherein the pre-set convolutional neural network model comprises a first convolutional layer, a second convolutional layer and a third convolutional layer, the first convolutional layer and the second convolutional layer are configured to input the training set, the third convolutional layer is configured to generate an interpolated frame according to an output frame of the first convolutional layer and an output frame of the second convolutional layer.

11. The computer-readable storage medium according to claim 10, wherein the first convolutional layer is configured to input the frame prior to the current frame or the frame after the current frame of the training set, and the second convolutional layer is configured to input the current frame, the frame prior to the current frame and the frame after the current frame of the of the training set.

12. The computer-readable storage medium according to claim 9, wherein the training set comprises a standard data set and an application scenario data set, prior to inputting the current frame, the frame prior to the current frame and the frame after the current frame of the video to which the frames to be interpolated into a preconfigured video frame interpolation model, the method further includes the steps of:
successively determining a current frame, a frame prior to the current frame and a frame after the current frame of the standard data set;
inputting the current frame, a frame prior to the current frame and a frame after the current frame of the standard data set into the pre-set convolutional neural network model for training, to obtain an initial model;
successively determining the current frame, a frame prior to the current frame and a frame after the current frame of the application scenario data set; and
inputting the current frame, the frame prior to the current frame and the frame after the current frame of the application scenario data set into the initial model for training, to generate the video frame interpolation model.

13. A terminal, comprising:
one or more processors; and
a storage device configured for storing one or more programs,
wherein when the one or more programs are executed by the one or more processors, the one or more processors implement a video frame interpolation method comprises the steps of:
successively determining a current frame, a frame prior to the current frame and a frame after the current frame of a video to which a frame to be interpolated;
inputting the current frame, the frame prior to the current frame and the frame after the current frame of the video to which the frames to be interpolated into a pre-configured video frame interpolation model, wherein the video frame interpolation model is configured by training a pre-set convolutional neural network model with current frames, frames prior to the current frames and frames after the current frames in a training set; and
performing frame interpolation on the video to which the frames to be interpolated via the video frame interpolation model, and obtaining a frame interpolated video.

14. The terminal according to claim 13, wherein the pre-set convolutional neural network model comprises a first convolutional layer, a second convolutional layer and a third convolutional layer, the first convolutional layer and the second convolutional layer are configured to input the training set, the third convolutional layer is configured to generate an interpolated frame according to an output frame of the first convolutional layer and an output frame of the second convolutional layer.

15. The terminal according to claim 14, wherein the first convolutional layer is configured to input the frame prior to the current frame or the frame after the current frame of the training set, and the second convolutional layer is configured to input the current frame, the frame prior to the current frame and the frame after the current frame of the of the training set.
